(19) United States
(12) Patent Application Publication
(10) Pub. No.: US 2026/0264449 A1
(43) Pub. Date: Sep. 10, 2026

(54) MULTI-PIECE OMNIDIRECTIONAL WHEEL

(71) Applicant: Guangdong Prestige Technology Company Limited, Dongguan, Guangdong (CN)

(72) Inventor: Zhao Zhang, Dongguan, Guangdong (CN)

(21) Appl. No.: 19/167,355

(22) PCT Filed: May 24, 2024
(86) PCT No.: PCT/CN2024/095105

§ 371 Date: Sep. 19, 2025

(30) Foreign Application Priority Data
Apr. 3, 2023 (CN) 202320713250.4

(51) Int. Cl. B60B 19/12; B60B 19/00; B60B 25/00

(52) U.S. Cl. CPC B60B 19/12; B60B 19/003; B60B 25/006

(57) ABSTRACT

A multi-piece omnidirectional wheel includes a rim and a plurality of wheel piece assemblies circumferentially arranged on the periphery of the rim. Each wheel piece assembly includes a wheel piece, a wheel piece support and a bearing. The wheel piece bracket is arranged on the rim, and a mounting shaft protrudes from the wheel piece bracket, a connecting shaft protruding from the mounting shaft. A connecting hole is recessed into the wheel piece bracket. The connecting shaft of one of two adjacent wheel piece supports is sleeved in the connecting hole of the other one of the two adjacent wheel piece brackets. The wheel pieces are mounted on the mounting shafts by means of the bearings, and the central axis of the wheel pieces are perpendicular to the central axis of the rim. The multi-piece universal wheel has advantages such as flexible steering, simple structure and convenient assembly.

### FIELD OF THE INVENTION

The present invention relates to an omnidirectional wheel, and more particularly to a multi-piece omnidirectional wheel.

### BACKGROUND OF THE INVENTION

Existing omnidirectional wheels generally utilize multiple roller sets assembled on a rim to achieve rolling in both forward/backward and left/right directions. A roller set includes a bracket, a large roller, and a pair of small rollers. The large roller is pivotally connected to the bracket, and the small rollers are located on either side of the large roller and are also pivotally connected to the bracket. Obviously, this omnidirectional wheel includes two different types of rollers, which requires the bracket to be manufactured specially to fit with the different rollers. This not only complicates the structure of the omnidirectional wheel but also makes installation cumbersome and assembly inconvenient

### SUMMARY OF THE INVENTION

The objective of the present invention is to provide a multi-piece omnidirectional wheel that offers flexible steering, a simple structure, and convenient assembly.

In order to achieve the above objective, the present invention provides a multi-piece omnidirectional wheel, including a rim and a plurality of wheel piece assemblies. The wheel piece assemblies are arranged circumferentially around an outer periphery of the rim about a central axis of the rim. Each of the wheel piece assemblies includes a wheel piece, a wheel piece bracket, and a bearing. The wheel piece bracket is arranged on the rim and has one side protruding with a mounting shaft, and a front end of the mounting shaft is protruded with a connecting shaft. A side of the wheel piece bracket opposite to the connecting shaft is recessed with a connecting hole, and the connecting shaft of one of two adjacent wheel piece brackets is sleeved within the connecting hole of the other one of the two adjacent wheel piece brackets. The wheel piece is mounted on the mounting shaft via the bearing, and a central axis of the wheel piece is perpendicular to the central axis of the rim.

Compared to the prior art, the wheel piece brackets of the present invention are arranged on the rim, one side of the wheel piece brackets is provided with the mounting shafts and the connecting shafts, while the other side is provided with the connecting holes. By sleeving the connecting shaft of one of two adjacent wheel piece brackets into the connecting hole of the other, the wheel piece brackets are arranged circumferentially around the central axis of the rim. The wheel pieces are then correspondingly provided on the wheel piece brackets one by one, so that the wheel pieces are arranged circumferentially around the central axis of the rim. Therefore, these wheel pieces collectively form an integrated wheel, enabling the entire omnidirectional wheel to achieve rolling forward and backward around the central axis of the rim. Furthermore, since each wheel piece is mounted on the wheel piece bracket via the bearing, each wheel piece can individually roll around the mounting shaft, enabling the entire omnidirectional wheel to achieve rolling in left and right directions. Consequently, the omnidirectional wheel of the present invention can perform multi-directional rolling with flexible steering. Moreover, when assembling, it only requires assembling the wheel piece, bearing, and wheel piece bracket into a wheel piece assembly, and then mounting multiple wheel piece assemblies onto the rim. Fewer parts are needed to bring a simple and compact structure, and the assembly is convenient.

Preferably, a central axis of the connecting hole intersects with a central axis of the connecting shaft. This allows the connecting shaft of one of two adjacent wheel piece brackets to be coaxially sleeved into the connecting hole of the other. Simultaneously, the various wheel piece brackets, after being connected, can form a circle around the central axis of the rim, thereby forming the omnidirectional wheel.

Preferably, the wheel piece bracket has a mounting plate, the rim is circumferentially provided with multiple positioning grooves about the central axis thereof, and the mounting plates are positioned within the positioning grooves. By fixing the mounting plates within the positioning grooves, the wheel piece brackets and the wheel pieces can be supported on the rim, thereby ensuring the structural stability.

Specifically, the wheel piece bracket and the mounting plate are integrally formed into one piece, which simplifies the structure and enhances the convenience of assembly.

Specifically, an outer side of the rim is circumferentially recessed with a mounting groove, and the positioning grooves are arranged on an inner wall of the mounting groove. The mounting groove can accommodate the wheel piece brackets, thereby concealing the brackets and exposing only the wheel pieces, which improves the appearance of the omnidirectional wheel. It also makes the overall volume of the omnidirectional wheel smaller and its structure more compact and rational.

Preferably, an outer periphery of an end of the mounting shaft proximate to the wheel piece bracket is provided with a limiting ring. An outer periphery of an end of the mounting shaft proximate to the connecting shaft is provided with a first accommodation groove for accommodating a first circlip. The first circlip and the limiting ring limit an inner ring of the bearing.

Preferably, a first wall surface of the wheel piece bracket proximate to the connecting hole is inclined relative to a second wall surface of the wheel piece bracket proximate to the mounting shaft. A central axis of the connecting hole is perpendicular to the first wall surface. The mounting shaft and the connecting shaft are perpendicular to the second wall surface. This configuration makes the integrated molding process for the connecting hole, mounting shaft, and connecting shaft easier and more convenient, which is beneficial for simplifying the structure and improving the convenience of assembly.

Preferably, an inner wall of the wheel piece is provided with a limiting edge at one end and a second accommodation groove for accommodating a second circlip at the other end. The second circlip and the limiting edge limit an outer ring of the bearing. This not only improves the convenience of assembly but also ensures the stability of the connection between the bearing and the wheel piece.

Preferably, the wheel piece includes an inner wheel and an outer wheel sleeve. The outer wheel sleeve is fixedly sleeved around the outer periphery of the inner wheel.

Preferably, the rim includes a left rim and a right rim, which are fixedly connected coaxially. By configuring the rim as a combination of a left rim and a right rim, processing of the rim is facilitated, and the installation of the wheel piece assemblies is easier, thereby improving the convenience of assembly.

### BRIEF DESCRIPTION OF THE DRAWINGS

FIG. 1 is a perspective view of the multi-piece omnidirectional wheel according to the present invention.

FIG. 2 is an exploded view of the multi-piece omnidirectional wheel according to the present invention.

FIG. 3 is a structural view of the multi-piece omnidirectional wheel according to the present invention with one side of the rim removed.

FIG. 4 is a perspective view of a single wheel piece assembly of the multi-piece omnidirectional wheel according to the present invention.

FIG. 5 is an exploded view of a single wheel piece assembly of the multi-piece omnidirectional wheel according to the present invention.

FIG. 6 is a radial cross-sectional view of the multi-piece omnidirectional wheel according to the present invention.

FIG. 7 is a cross-sectional view showing the connection between two adjacent wheel piece assemblies in FIG. 6.

FIG. 8 is a cross-sectional view of the wheel piece bracket of the multi-piece omnidirectional wheel according to the present invention.

FIG. 9 is an axial cross-sectional view of the multi-piece omnidirectional wheel according to the present invention.

### DETAILED DESCRIPTION OF ILLUSTRATED EMBODIMENTS

To elaborate the technical content, structural features, and achieved effects of the present invention, the following description is provided in conjunction with the embodiments and the drawings for a detailed explanation.

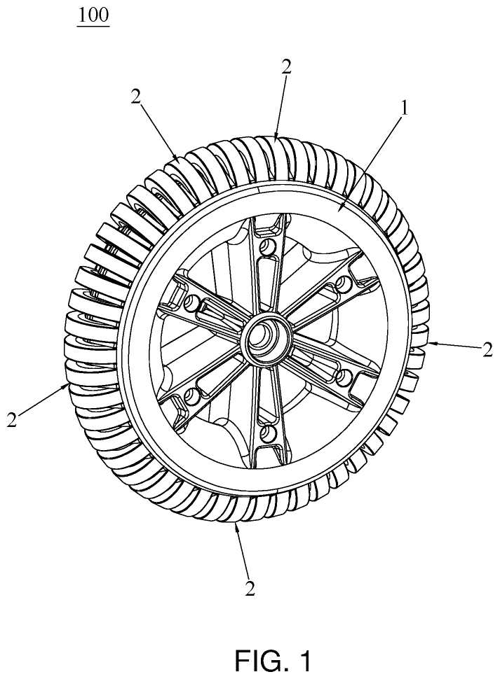

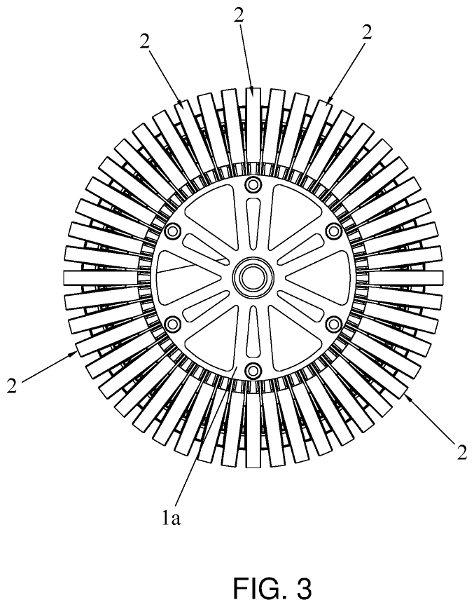

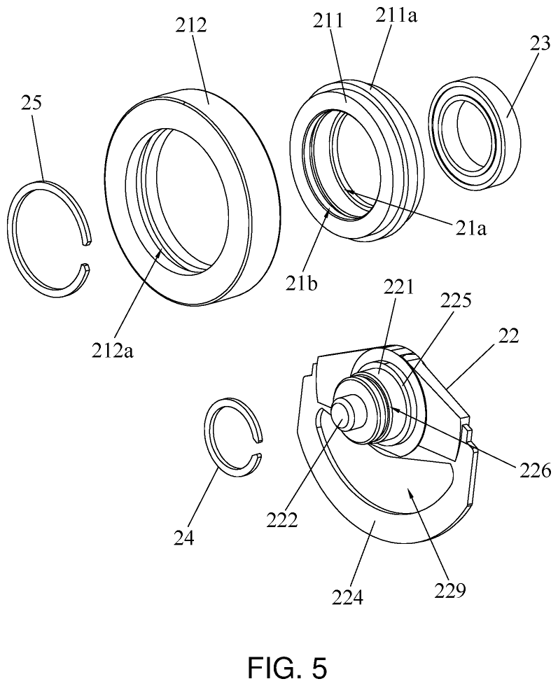

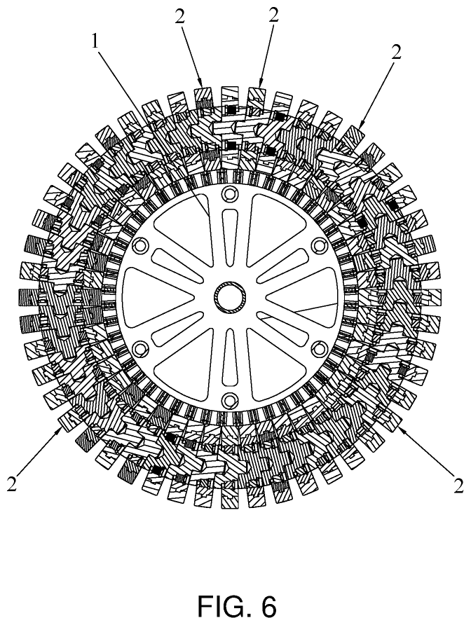

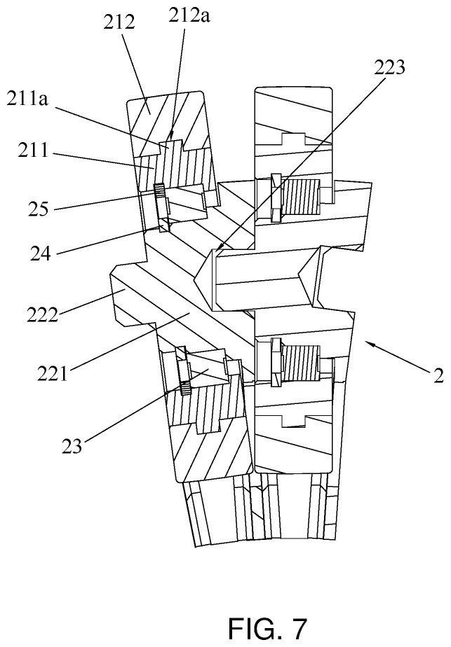

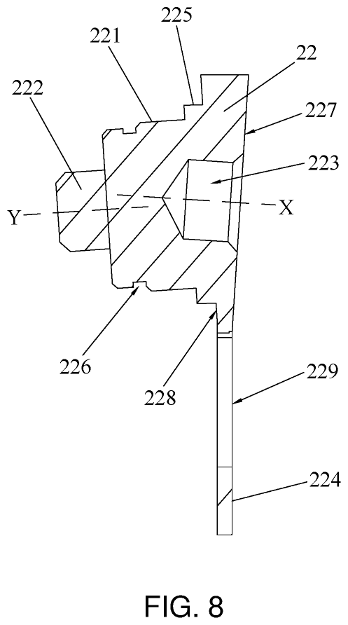

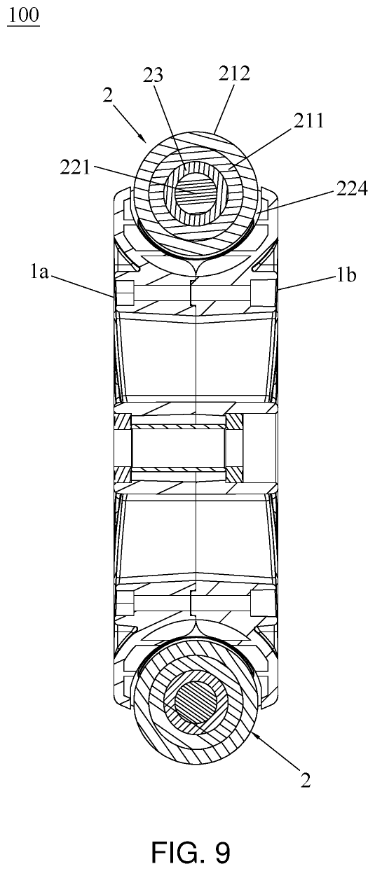

As shown in FIGS. 1 to 9, the multi-piece omnidirectional wheel 100 of the present invention includes a rim 1 and a plurality of wheel piece assemblies 2. The rim 1 is circular. The wheel piece assemblies 2 are arranged circumferentially around an outer periphery of the rim 1 about a central axis of the rim 1. Each wheel piece assembly 2 includes a wheel piece 21, a wheel piece bracket 22, and a bearing 23. The wheel piece bracket 22 is arranged on the rim 1 and has one side protruding with a mounting shaft 221. A front end of the mounting shaft 221 protrudes with a connecting shaft 222. The mounting shaft 221 and the connecting shaft 222 are arranged coaxially. A side of the wheel piece bracket 22 opposite to the connecting shaft 222 is recessed with a connecting hole 223. The connecting shaft 222 of one of two adjacent wheel piece brackets 22 is sleeved within the connecting hole 223 of the other one of the two adjacent wheel piece brackets 22. A central axis X of the connecting hole 223 intersects with a central axis Y of the connecting shaft 222. This allows the connecting shaft 222 of one of two adjacent wheel piece brackets 22 to be coaxially sleeved into the connecting hole 223 of the other one of the two adjacent wheel piece brackets 22. Furthermore, the various wheel piece brackets 22, after being connected, can naturally form a circle around the central axis of the rim 1, thereby forming the omnidirectional wheel. The wheel piece 21 is mounted on the mounting shaft 221 via the bearing 23, and a central axis of the wheel piece 21 is perpendicular to the central axis of the rim 1. The cross-section of the wheel piece 21 is annular. The inner ring of the bearing 23 is fixedly sleeved over the mounting shaft 221, and the outer ring of the bearing 23 is fixedly sleeved within an inner hole of the wheel piece 21. More specifically, in this embodiment, the number of wheel piece assemblies 2 is 48, and the central angle between two adjacent wheel piece assemblies 2 is 7.5 degrees. Optionally, the number of wheel piece assemblies 2 may also be fewer or greater. A person skilled in the art can calculate the central angle between two adjacent wheel piece assemblies 2 based on the number of wheel piece assemblies 2 and the radius of the omnidirectional wheel, and thereby calculate the intersection angle between the central axis of the connecting shaft 222 and the central axis of the connecting hole 223, as well as the length of the connecting shaft 222 and the depth of the connecting hole 223; and details will not be explained here.

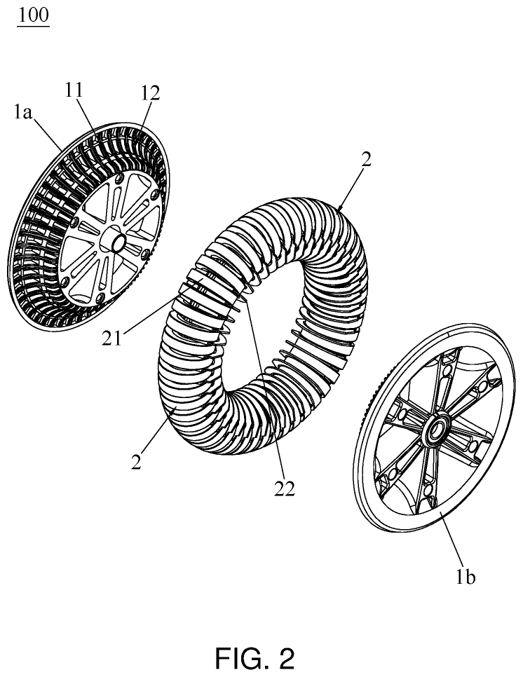

Referring to FIGS. 2, 5, and 7, each wheel piece bracket 22 has a mounting plate 224. The rim 1 is circumferentially provided with positioning grooves 11 about its central axis. The number of positioning grooves 11 is the same as the number of wheel piece brackets 22. The plane in which the positioning grooves 11 lie is parallel to the central axis of the rim 1. The mounting plates 224 are positioned within the positioning grooves 11. By fixing the mounting plates 224 within the positioning grooves 11, the wheel piece brackets 22 and the wheel pieces 21 can be supported on the rim 1, thereby ensuring the structural stability. The wheel piece bracket 22 and the mounting plate 224 are integrally formed into one piece, which simplifies the structure and improves the convenience of assembly. Furthermore, a hollowed space 229 is formed between the mounting plate 224 and the main body of the wheel piece bracket 22, and the hollowed space 229 is configured to accommodate a portion of the wheel piece 21 of an adjacent wheel piece assembly 2 when the wheel piece assemblies 2 are arranged circumferentially, thereby making the structure more compact. An outer periphery of an end of the mounting shaft 221 proximate to the wheel piece bracket 22 is provided with a limiting ring 225. An outer periphery of an end of the mounting shaft 221 proximate to the connecting shaft 222 is provided with a first accommodation groove 226 for accommodating a first circlip 24. The first accommodation groove 226 is annular. The first circlip 24 and the limiting ring 225 limit the inner ring of the bearing 23. A first wall surface 227 of the wheel piece bracket 22 proximate to the connecting hole 223 is inclined relative to a second wall surface 228 of the wheel piece bracket 22 proximate to the mounting shaft 221. A central axis of the connecting hole 223 is perpendicular to the first wall surface 227. The mounting shaft 221 and the connecting shaft 222 are perpendicular to the second wall surface 228. These arrangements can make the integrated molding process for the connecting hole 223, mounting shaft 221, and connecting shaft 222 easier and more convenient, which is beneficial for simplifying the structure and improving the convenience of assembly.

Referring to FIGS. 1 to 3, the outer side of the rim 1 is circumferentially recessed with a mounting groove 12. The positioning grooves 11 are arranged on the inner wall of the mounting groove 12. The wheel piece brackets 22 are accommodated within the mounting groove 12, and the wheel pieces 21 extend outward beyond the mounting groove 12. The mounting groove 12 can accommodate the wheel piece brackets 22, thereby concealing the brackets 22 and exposing only the wheel pieces 21, which improves the appearance of the omnidirectional wheel, and also makes the overall volume of the omnidirectional wheel smaller to obtain compact structure.

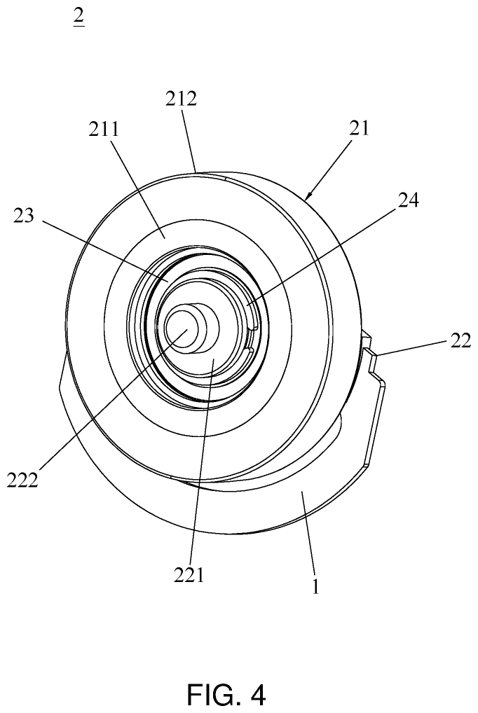

Referring to FIGS. 4, 5, and 7, an inner wall of the wheel piece 21 is provided with a limiting edge 21a at one end and a second accommodation groove 21b for accommodating a second circlip 25 at the other end. The second circlip 25 and the limiting edge 21a limit the outer ring of the bearing 23. In such a way, it not only improves the convenience of assembly but also ensures the stability of the connection between the bearing 23 and the wheel piece 21. Specifically, the wheel piece 21 includes an inner wheel 211 and an outer wheel sleeve 212. The outer wheel sleeve 212 is fixedly sleeved around the outer periphery of the inner wheel 211. The outer wheel sleeve 212 can be made of a relatively soft and wear-resistant material, such as rubber. The inner wheel 211 can be made of a material with higher hardness, such as aluminum alloy. The limiting edge 21a and the second accommodation groove 21b are both provided on the inner wheel 211. More specifically, the outer surface of the inner wheel 211 is circumferentially provided with positioning ribs 211a. The inner wall of the outer wheel sleeve 212 is circumferentially provided with engagement slots 212a which are for engaging with the positioning ribs 211a, thereby allowing the outer wheel sleeve 212 and the inner wheel 211 to be relatively fixed, and enhancing the stability of the connection.

As shown in FIG. 2, the rim 1 includes a left rim la and a right rim 1b. The left rim la and the right rim 1b are fixedly connected coaxially by bolts. By configuring the rim 1 as a combination of a left rim la and a right rim 1b, processing of the rim 1 is facilitated, and the installation of the wheel piece assemblies 2 is easier, thereby improving the convenience of assembly.

Compared to the prior art, the wheel piece brackets 22 of the present invention are arranged on the rim 1, one side of the wheel piece brackets 22 is provided with the mounting shafts 221 and the connecting shafts 222, while the other side is provided with the connecting holes 223. By sleeving the connecting shaft 222 of one of two adjacent wheel piece brackets 22 into the connecting hole 223 of the other, the wheel piece brackets 22 are arranged circumferentially around the central axis of the rim 1. The wheel pieces 21 are then correspondingly provided on the wheel piece brackets 22 one by one, so that the wheel pieces 21 are arranged circumferentially around the central axis of the rim 1. Therefore, these wheel pieces 21 collectively form an integrated wheel, enabling the entire omnidirectional wheel to achieve rolling forward and backward around the central axis of the rim 1. Furthermore, since each wheel piece 21 is mounted on the wheel piece bracket 22 via the bearing 23, each wheel piece 21 can individually roll around the mounting shaft 221, enabling the entire omnidirectional wheel to achieve rolling in left and right directions. Consequently, the omnidirectional wheel of the present invention can perform multi-directional rolling with flexible steering. Moreover, when assembling, it only requires assembling the wheel piece 21, bearing 23, and wheel piece bracket 22 into a wheel piece assembly 2, and then mounting multiple wheel piece assemblies 2 onto the rim 1. Fewer parts are needed to bring a simple and compact structure, and the assembly is convenient.

The above descriptions are merely preferred embodiments of the present application and are not intended to limit the scope of the application. Any modifications, equivalent substitutions, or improvements made within the spirit and principles of the present application should be included within the protection scope of the present application.

1. A multi-piece omnidirectional wheel, comprising a rim and a plurality of wheel piece assemblies, wherein the wheel piece assemblies are arranged circumferentially around an outer periphery of the rim about a central axis of the rim; each of the wheel piece assemblies comprises a wheel piece, a wheel piece bracket, and a bearing; the wheel piece bracket is arranged on the rim and has one side protruding with a mounting shaft, a front end of the mounting shaft is protruded with a connecting shaft; a side of the wheel piece bracket opposite to the connecting shaft is recessed with a connecting hole; the connecting shaft of one of two adjacent wheel piece brackets is sleeved within the connecting hole of the other one of the two adjacent wheel piece brackets; the wheel piece is mounted on the mounting shaft via the bearing, and a central axis of the wheel piece is perpendicular to the central axis of the rim;
wherein the wheel piece bracket has a mounting plate, the rim is circumferentially provided with multiple positioning grooves about the central axis thereof, and the mounting plates are positioned within the positioning grooves;
a hollowed space is formed between the mounting plate and a main body of the wheel piece bracket, and the hollowed space is configured to accommodate a portion of the wheel piece of an adjacent wheel piece assembly when the wheel piece assemblies are arranged circumferentially.

2. The multi-piece omnidirectional wheel according to claim 1, wherein a central axis of the connecting hole intersects with a central axis of the connecting shaft.

3. (canceled)

4. The multi-piece omnidirectional wheel according to claim 13, wherein the wheel piece bracket and the mounting plate are integrally formed into one piece.

5. The multi-piece omnidirectional wheel according to claim 13, wherein an outer side of the rim is circumferentially recessed with a mounting groove, and the positioning grooves are arranged on an inner wall of the mounting groove.

6. The multi-piece omnidirectional wheel according to claim 1, wherein an outer periphery of an end of the mounting shaft proximate to the wheel piece bracket is provided with a limiting ring; an outer periphery of an end of the mounting shaft proximate to the connecting shaft is provided with a first accommodation groove for accommodating a first circlip; and an inner ring of the bearing is limited by the first circlip and the limiting ring.

7. The multi-piece omnidirectional wheel according to claim 1, wherein a first wall surface of the wheel piece bracket proximate to the connecting hole is inclined relative to a second wall surface of the wheel piece bracket proximate to the mounting shaft; a central axis of the connecting hole is perpendicular to the first wall surface; and the mounting shaft and the connecting shaft are perpendicular to the second wall surface.

8. The multi-piece omnidirectional wheel according to claim 1, wherein an inner wall of the wheel piece is provided with a limiting edge at one end and a second accommodation groove for accommodating a second circlip at another end, and an outer ring of the bearing is limited by the second circlip and the limiting edge.

9. The multi-piece omnidirectional wheel according to claim 1, wherein the wheel piece comprises an inner wheel and an outer wheel sleeve, and the outer wheel sleeve is fixedly sleeved around an outer periphery of the inner wheel.

10. The multi-piece omnidirectional wheel according to claim 1, wherein the rim comprises a left rim and a right rim, which are fixedly connected coaxially.
